(19) United States
(12) Patent Application Publication
(10) Pub. No.: US 2008/0319951 A1
(43) Pub. Date: Dec. 25, 2008

(54) APPARATUS AND METHOD FOR CLASSIFYING TIME-SERIES DATA AND TIME-SERIES DATA PROCESSING APPARATUS

(75) Inventors: Ken Ueno, Tokyo (JP); Ryohei Orihara, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/142,070

(22) Filed: Jun. 19, 2008

(30) Foreign Application Priority Data
Jun. 19, 2007 (JP) 2007-161399

(51) Int. Cl. G06F 7/06; G06F 17/30

(52) U.S. Cl. 707/3; 707/100; 707/E17.046; 707/E17.014

(57) ABSTRACT

A time-series data classifying apparatus may include a first database, a peak feature extracting unit, a second database, a data input unit, and a predicting unit. The first database stores a plurality of cases each including time-series data a classification label. The peak feature extracting unit may, for each of the cases, calculate intersection points of time-series data expanded in a coordinate system and each reference line, detect a peak point in each of sections formed between two intersection points being adjacent to generate a peak feature sequence that contains a sequence of detected peak points. The second database may store each peak feature sequence in association with a classification label of each of the cases. The data input unit may input target time-series data. The predicting unit may predict a classification label to be assigned to the target time-series data based on the second database.

### CROSS REFERENCE TO RELATED APPLICATIONS

This application is based upon and claims the benefit of priority from the prior Japanese Patent Applications No. 2007-161399, filed on Jun. 19, 2007; the entire contents of which are incorporated herein by reference.

### BACKGROUND OF THE INVENTION

1. Field of the Invention

The present invention relates to a time-series data classifying apparatus and time-series data classifying method for classifying time-series data as well as a time-series data processing apparatus for processing time-series data.

2. Related Art

It is known that time-series data obtained from a sensor is enormous and redundant and is difficult to classify with high accuracy even by applying a highly accurate data mining technique which learns or trains using time-series data that has a known result of classification. To avoid this problem, feature extraction tailored to individual problems is said to be necessary. However, when features of a time-series waveform are not specifically defined in advance, an existing method for feature extraction may be inappropriate and lower the accuracy of classification. Feature calculation using waveform segmentation with a fixed window width, which has been conventionally in common use, has a known problem that phase information, peak positions and the features of an original waveform cannot be maintained when the window width is too small ([Keogh 05] Eamonn J Keogh, Jessica Lin: Clustering of time-series subsequences is meaningless: implications for previous and future research. Knowl. Inf. Syst. 8(2): 154-177 (2005)). One method available is to discretize a subsequence waveform within a fixed window size and assign a symbol label to time-series data in units of the window width to thereby convert the data into a symbol string, but conversion to symbols may be inappropriate for classification/identification when variation of amplitude is significant.

### SUMMARY OF THE INVENTION

According to an aspect of the present invention, there is provided with a time-series data classifying apparatus, comprising:

a first database configured to store a plurality of cases each including
time-series data in which an observed value obtained by observing an observation object is sequentially recorded in associated with an observed time and
a classification label that represents a state or type of the observation object as when the observation object is observed;

a peak feature extracting unit configured to, for each of the cases,
expand the time-series data in a coordinate system which is made up of a time axis and a value axis representing the observed value,
set along the time axis a reference line that intersects expanded time-series data,
detect intersection points of the expanded time-series data and the reference line, and
detect a peak point of the expanded time-series data in each of sections each formed between two intersection points being adjacent to generate a peak feature sequence that contains the peak point detected in each of the sections;

a second database configured to store the peak feature sequence generated for each of the cases in association with a classification label of each of the cases;

a data input unit configured to input target time-series data; and

a predicting unit configured to predict a classification label to be assigned to the target time-series data, based on the second database.

According to an aspect of the present invention, there is provided with a time-series data classifying apparatus, comprising:

a first database configured to store a plurality of cases each including
time-series data in which an observed value obtained by observing an observation object is sequentially recorded in associated with an observed time and
a classification label that represents a state or type of the observation object as when the observation object is observed;

a peak feature extracting unit configured to, for each of the cases,
expand the time-series data in a coordinate system which is made up of a time axis and a value axis representing the observed value,
set along the time axis a reference line that intersects expanded time-series data,
detect intersection points of the expanded time-series data and the reference line, and
detect a peak point of the expanded time-series data in each of sections each formed between two intersection points being adjacent to generate a peak feature sequence that contains the peak point detected in each of the sections;

a second database configured to store the peak feature sequence generated for each of the cases in association with a classification label of each of the cases.

According to an aspect of the present invention, there is provided with a time-series data classifying method, comprising:

providing a first database which stores a plurality of cases each including
time-series data in which an observed value obtained by observing an observation object is sequentially recorded in associated with an observed time and
a classification label that represents a state or type of the observation object as when the observation object is observed;

for each of the cases, expanding the time-series data in a coordinate system which is made up of a time axis and a value axis representing the observed value, setting along the time axis a reference line that intersects expanded time-series data, detecting intersection points of the expanded time-series data and the reference line, and detecting a peak point of the expanded time-series data in each of sections each formed between two intersection points being adjacent to generate a peak feature sequence that contains the peak point detected in each of the sections;

storing the peak feature sequence generated for each of the cases in association with a classification label of each of the cases, in a second database;

inputting target time-series data; and

predicting a classification label to be assigned to the target time-series data based on the second database.

### BRIEF DESCRIPTION OF THE DRAWINGS

FIG. 1 shows a configuration of a time-series data classifying apparatus as a first embodiment of the present invention;

FIG. 2 shows an example of a training time-series data database;

FIG. 3 shows examples of time-series data (waveforms) A and B having different classification labels;

FIG. 4 shows an example of noise processing;

FIG. 5 shows an example of a selected waveform database;

FIG. 6 shows an example of processing by a waveform selecting unit;

FIG. 7 shows examples of scaling of waveforms A and B by drawing reference lines for the waveforms A and B;

FIG. 8 shows intersection points of the reference line and waveforms A and B;

FIG. 9 shows a peak detection example 1;

FIG. 10 shows a peak detection example 2;

FIG. 11 shows a peak detection example 3;

FIG. 12 shows an example of a peak feature sequence obtained from waveform “A”;

FIG. 13 shows peak points detected from waveform “A”;

FIG. 14 shows an example of a peak feature sequence obtained from waveform “B”;

FIG. 15 shows an example of a peak feature sequence database;

FIG. 16 shows a processing flow of a peak feature extracting unit;

FIG. 17 shows an example of a significant peak feature sequence database;

FIG. 18 shows an example 1 of calculation for peak selection (calculation of a significant peak feature sequence);

FIG. 19 shows an example 2 of calculation for peak selection (calculation of a significant peak feature sequence);

FIG. 20 shows an example of feature points (a significant peak feature sequence) selected from time-series data;

FIG. 21 shows an example of distance calculation by a peak selecting unit;

FIG. 22 shows another example of distance calculation by the peak selecting unit;

FIG. 23 shows an example of an unclassified time-series data database;

FIG. 24 shows an example of distance calculation by a predicting unit;

FIG. 25 shows another example of distance calculation by the predicting unit;

FIG. 26 shows an example of detailed peak detection (detection example 4);

FIG. 27 shows an example of feature point extraction that utilizes a property of maximum perpendicular length;

FIG. 28 shows an example of feature point extraction that utilizes a perpendicular;

FIG. 29 shows how to calculate a length of a perpendicular;

FIG. 30 shows an example of feature point extraction that utilizes translation of a movable straight line;

FIG. 31 shows an example of feature point extraction that follows FIG. 30;

FIG. 32 shows another example of feature point extraction that utilizes translation of a movable straight line;

FIG. 33 shows an example 2 of a peak feature vector in waveform “A”;

FIG. 34 illustrates calculation of significance of a peak point;

FIG. 35 illustrates calculation of significance of a peak point following FIG. 34;

FIG. 36 shows accuracy of significant peak feature sequences; and

FIG. 37 shows a configuration of a time-series data reducing apparatus as a fifth embodiment of the invention.

### DETAILED DESCRIPTION OF THE INVENTION

### First Embodiment

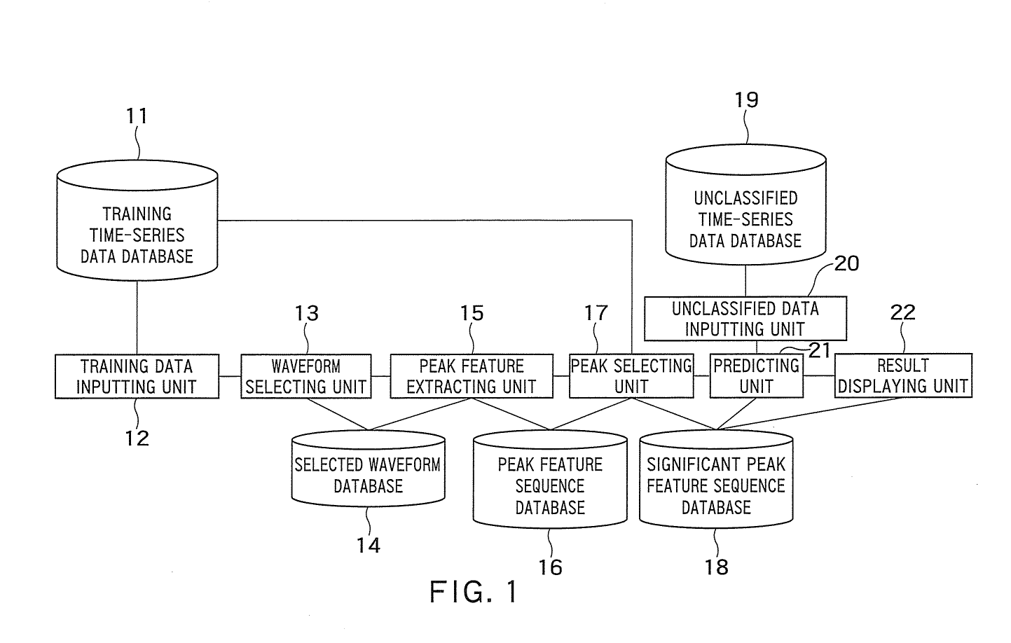

FIG. 1 is a block diagram showing a configuration of a time-series data classifying apparatus as a first embodiment of the invention.

A training time-series data database (a first database) 11 stores a plurality of cases that include time-series data which is chronological recording of observed values resulting from observation of an observation object e.g., by a sensor and a classification label which represents the state or type of the observation object as when time-series data is obtained. Time-series data is obtained by converting an analog signal acquired through a sensor into a digital signal by way of A/D conversion.

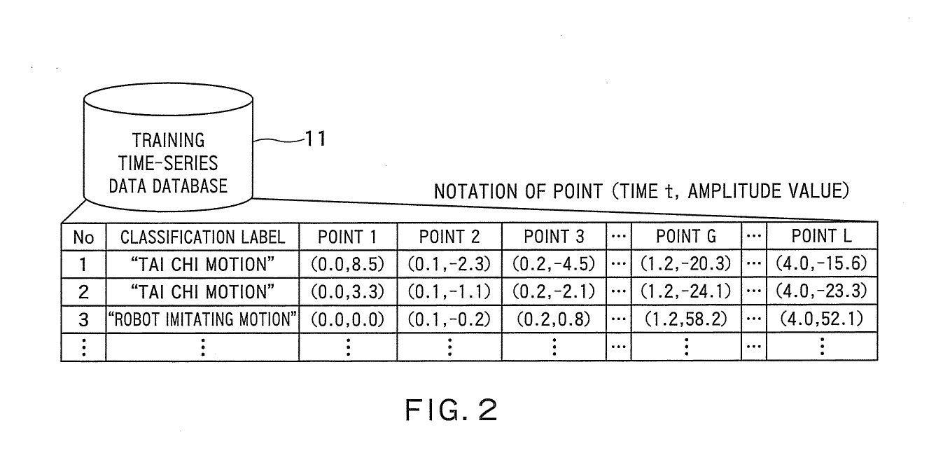

FIG. 2 shows an example of the training time-series data database 11.

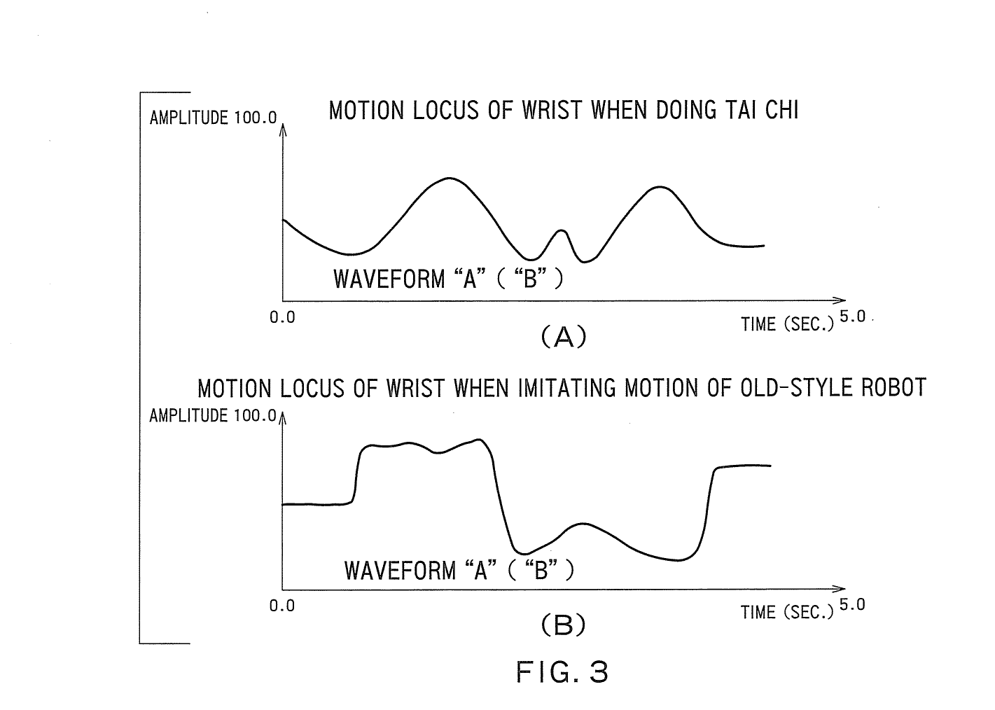

The database 11 has stored therein a plurality of cases including time-series data resulting from simplified motion capture and classification labels that represent a motion or gesture as when time-series data was obtained. The time-series data is recording of observed values (time “t” and an amplitude value) that are obtained at regular intervals for a predetermined time period. Herein, a piece of time-series data is made up of L observed values. Also, the time-series data is obtained from two states of an observation object. A first state is a motion of a wrist when doing Tai Chi and a label “Tai Chi motion” is given as a classification label that represents this state. A second state is a motion of a wrist when it imitates a motion of an old-style robot and a label “robot imitating motion” is given as a classification label that represent this state. An example of time-series data that represents the motion locus of a wrist during Tai Chi is shown in FIG. 3A as a waveform “A”, and an example of time-series data that represents the motion locus of a wrist when it imitates a motion of an old-style robot is shown in FIG. 3B as a waveform “B”¹.

This embodiment aims to, when time-series data which is not known to represent which one of the motions has been input, correctly predict and determine whether the inputted time-series data represents the motion A (Tai Chi motion) or motion B (robot imitating motion) by using time-series data which has a known state (or motion) result such as shown in FIG. 2.

Although this embodiment is described by illustrating determination of a motion by way of simplified motion capture, the present invention is also applicable to device monitoring, failure prediction, anomaly discovery and the like in addition to motion recognition.

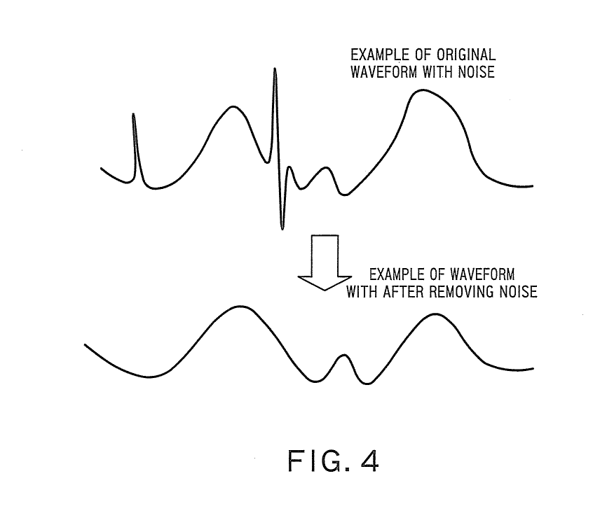

A training data inputting unit 12 of FIG. 1 reads out cases for training (time-series data and corresponding classification labels) from the training time-series data database 11 and inputs the cases to a waveform selecting unit 13. The training data inputting unit 12 may also conduct processing (pre-processing) for reducing effects of obvious noise or noise that is known in advance from time-series data using a smoothing filter. That is, the training data inputting unit 12 may have a noise removing unit for removing noise from time-series data. The training data inputting unit 12 may also normalize data by unifying units or using an average value, standard deviation (variance), minimum value, maximum value or the like calculated from waveform data. An example of noise removal from time-series data is illustrated in FIG. 4.

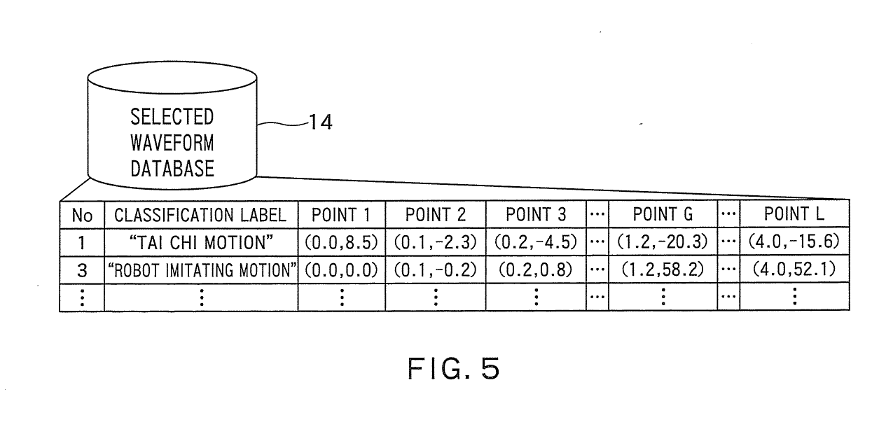

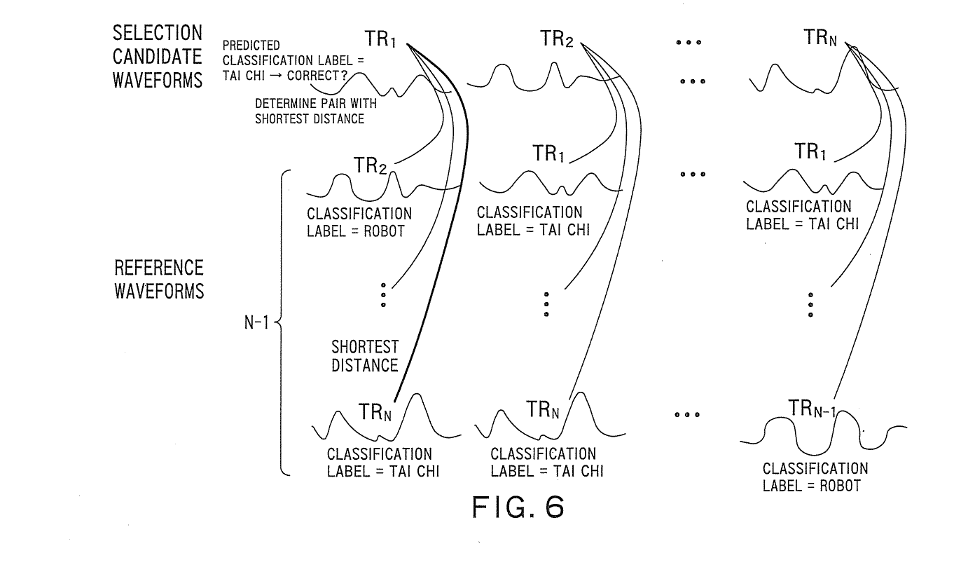

The waveform selecting unit (or case selecting unit) 13 selects a case that is unlikely to lead to misclassification from a case set inputted from the training data inputting unit 12 and records the selected case in a selected waveform database (a fourth database) 14. An example of the selected waveform database 14 is shown in FIG. 5. The waveform selecting unit 13 selects a case by Leave One Out method and k-Nearest Neighbor Classifier method, for example. A specific example of selection is illustrated in FIG. 6. The example of FIG. 6 uses 1-Nearest Neighbor Classifier method, wherein one case is taken from a case set as a selection candidate waveform, and time-series data (a reference waveform) that has the shortest distance to the selection candidate waveform taken is detected from among time-series data (reference waveforms) contained in the case set except the selection candidate waveform. If the classification label of the detected reference waveform is the same as that of the selection candidate waveform taken, the selection candidate waveform is adopted, and a case including the selection candidate waveform and the corresponding classification label is recorded in the waveform selecting unit 13. If the classification labels are not the same, the case including the selection candidate waveform taken and the corresponding classification label is not stored in the selected waveform database 14. By repeating processing similar to the above-described processing on all time-series data contained in the case set, the selected waveform database 14 is obtained.

A peak feature extracting unit 15 expands each piece of time-series data in the selected waveform database 14 in a coordinate system that is made up of a time axis and an axis representing an observed value, sets along the time axis a reference line that intersects the expanded time-series data, detects intersection points of the expanded time-series data and the reference line, and detects peak points (or feature points) of the expanded time-series data in sections which are formed by neighboring intersection points to generate a peak feature sequence, which is a set of peak points detected from each of the sections. This is described in greater detail below.

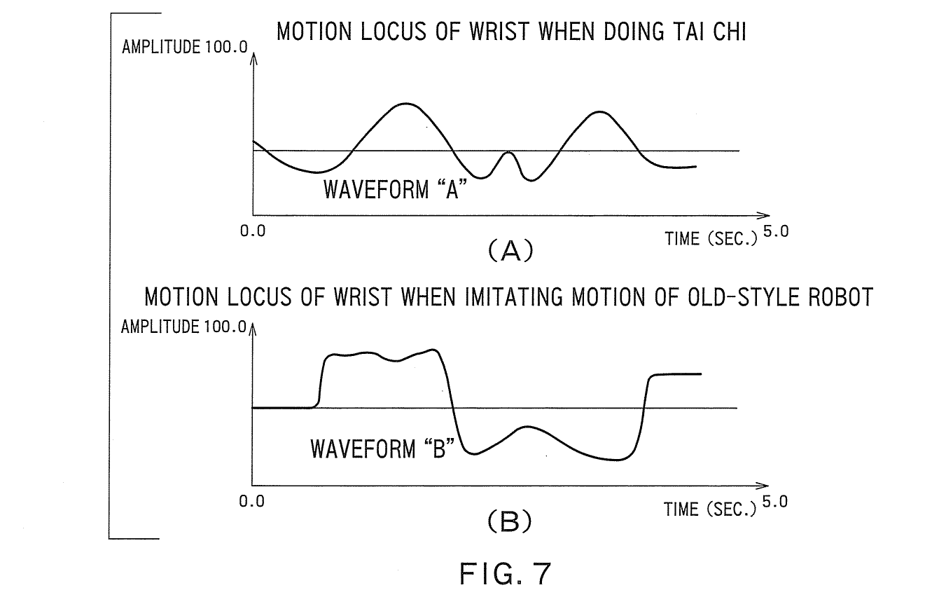

(1) Time-series data is expanded in the coordinate system, a reference value (e.g., an average value) in the amplitude direction in the time-series data is determined, and a straight line that passes through the reference value and is parallel with the time axis is drawn in the time-series data (i.e., the time-series data is scaled). This is equivalent to drawing the straight line so that areas defined by the straight line that passes through the reference value and the time-series data are equal above and below the straight line. Examples of scaled time-series data (waveforms) A and B of FIGS. 3A and 3B are shown in FIGS. 7A and 7B.

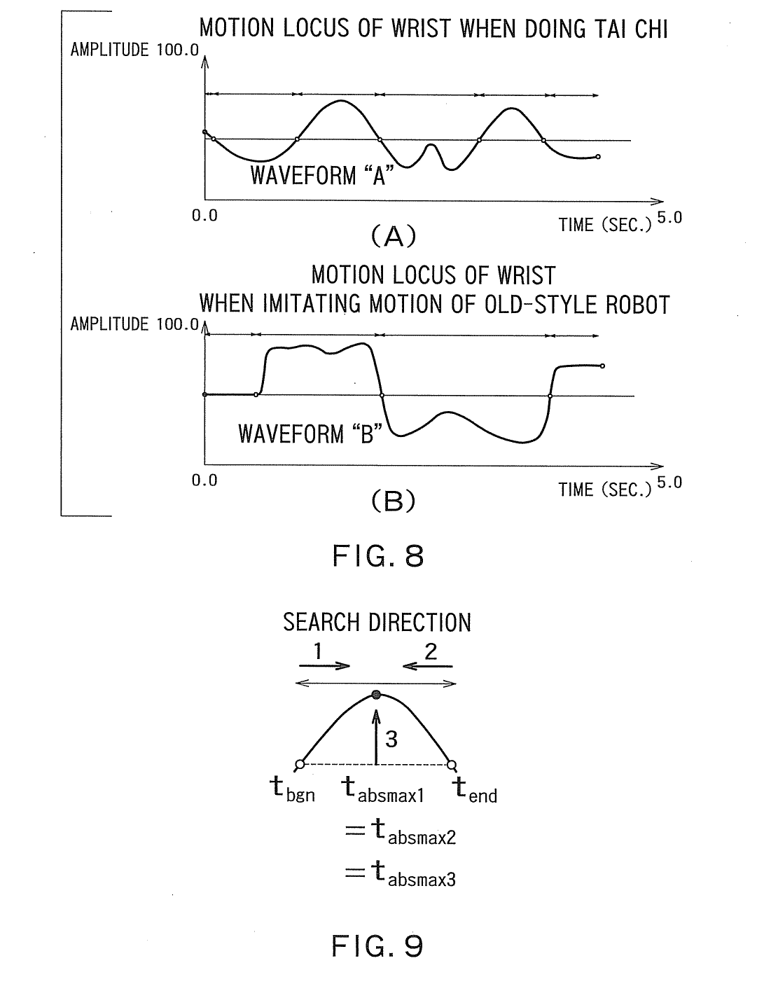

(2) All intersection points of the reference line that passes through the amplitude reference value and the time-series data (amplitude waveform) are obtained as waveform segmenting points. When the approximate shape of A/D-converted data intersects the reference line but actually does not completely corresponds with the reference line, a point that is closest to the intersection point of a waveform that represents the approximate shape of the data and the reference line is considered to be the intersection point, for example. In other words, when the reference line that runs across the time-series data expanded in the coordinate system passes between observation points, one of the two observation points lying across the reference line that is closer to the reference line is assumed to be the intersection point. As another way, a straight line that passes through the two observation points may be determined and the intersection points of the straight line determined and the reference line may be adopted. Alternatively, it is also possible to determine a curve that passes through the observation points in the time-series data by interpolation and adopt the intersection points of the curve and the reference line. In addition to the waveform segmenting points, start and end points of the waveform are also obtained. This is illustrated in FIG. 8, where a symbol “◯” represents a waveform segmenting point, the start or end point of the waveform.

Then, three types of peak points are determined between each two neighboring waveform segmenting points (a waveform segmenting section). Specifically, an “amplitude absolute value maximum time” and an amplitude value at this time, a “near-boundary anterior amplitude absolute value maximum time” and an amplitude value at this time, and a “near-boundary posterior amplitude absolute value maximum time” and an amplitude value at this time are determined.

The “amplitude absolute value maximum time” is a time at which a largest amplitude value (or a largest peak) is given in a waveform segmenting section, represented by the formula:

$${t}_{abs max} = {argmax}_{{t}_{bgn} \leq t \leq {t}_{end}} \vert f ( t ) \vert \qquad [ Formula 1 ]$$

Note that formula 1 shows the operation to find the most peaked time t_{absmax} from t_{bgn} to t_{end} in the waveform f(t). The “near-boundary anterior amplitude absolute value maximum time” is a time which gives a peak (a local peak) that is found first by performing a search in a waveform segmenting section from a waveform segmenting point (a section start point) that is anterior time toward a waveform segmenting point (a section end point) that is posterior in time.

The “near-boundary posterior amplitude absolute value maximum time” is a time which gives a peak (a local peak) that is found first by performing a search from the section end point toward the section start point.

FIGS. 9 to 12 illustrate examples of peak point calculation (Examples 1 to 3).

Example 1 shown in FIG. 9 illustrates a case where the “near-boundary anterior amplitude absolute value maximum time” (t_{absmax1}) coincides with the “near-boundary posterior amplitude absolute value maximum time” (t_{absmax2}). When the “near-boundary anterior amplitude absolute value maximum time” coincides with the “near-boundary posterior amplitude absolute value maximum time”, the “amplitude absolute value maximum time” (t_{absmax3}) also coincides with the “near-boundary anterior amplitude absolute value maximum time” and “near-boundary posterior amplitude absolute value maximum time”. Therefore, only one peak point is detected in the waveform segmenting section shown.

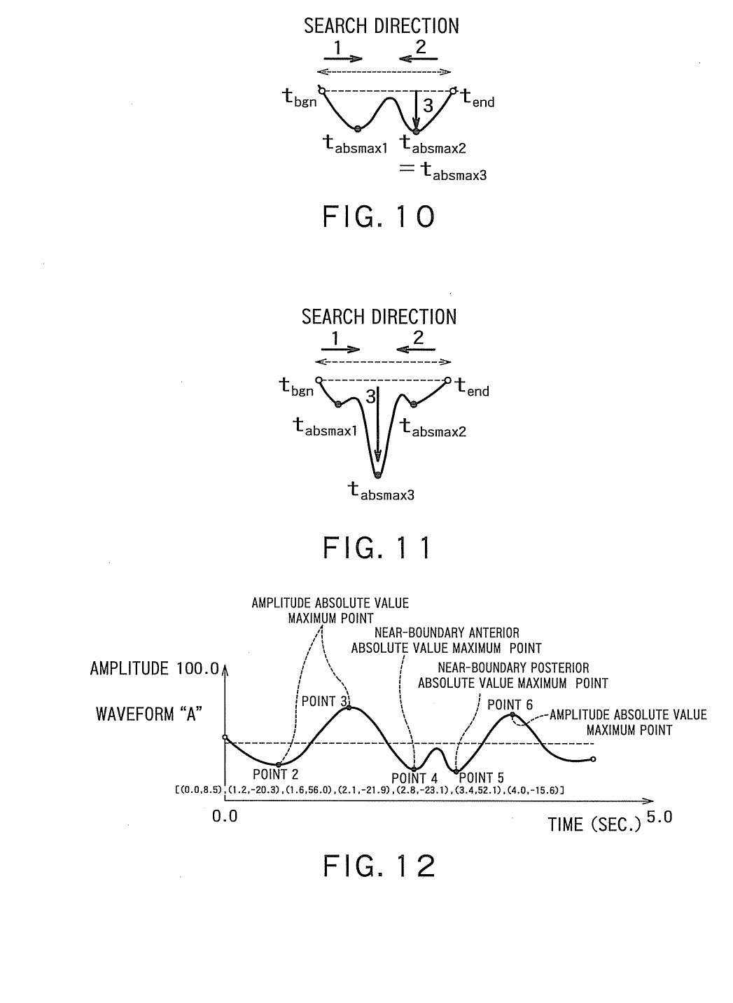

Example 2 of FIG. 10 illustrates a case where the “near-boundary posterior amplitude absolute value maximum time” coincides with the “amplitude absolute value maximum time” but not with the “near-boundary anterior amplitude absolute value maximum time”. Therefore, two peak points are detected in the waveform segmenting section shown.

Example 3 of FIG. 11 illustrates a case where none of the “near-boundary posterior amplitude absolute value maximum time”, “amplitude absolute value maximum time”, and “near-boundary anterior amplitude absolute value maximum time” coincides with each other. Therefore, three peak points are detected in the waveform segmenting section shown.

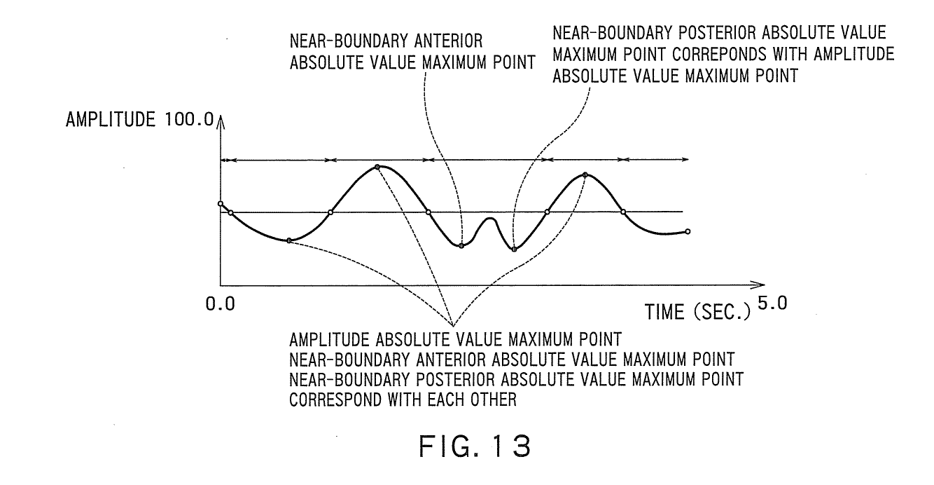

Peak points obtained from the waveform segmenting sections of the waveform “A” in FIG. 8A are shown in FIG. 13. Four waveform segmenting sections have been obtained from the waveform “A” of FIG. 8A and one peak point has been detected in each of the first, second, and fourth waveform segmenting sections because the three types of times coincide with each other in those sections. In the third waveform segmenting section, the “near-boundary posterior amplitude absolute value maximum time” coincides with the “amplitude absolute value maximum time” and not with the “near-boundary anterior amplitude absolute value maximum time”, thus two peak points have been detected.

In relation to peak detection, [Ueno 05] Ken Ueno and Koichi Furukawa, “Motion skill understanding by peak timing synergy—an approach with sequential pattern mining”, pp. 237-367, Journal of The Information Society for Artificial Intelligence, 2005 describes basic methods for feature point extraction and regularity discovery, but the document does not mention peak search in the forward and reverse directions. The document also does not mention retrieval of significant peaks as a classifier and the method described by the document leaves only peaks that appear with a high frequency and have commonality, which is thus different from the present invention.

As described, since this embodiment divides time-series data considering a portion between intersection points of time-series data and the reference line as one section, it can segment a waveform with a variable-length window width (the window width corresponds to the section width between intersection points in this embodiment) as appropriate for the characteristics of the waveform even when the frequency of amplitude variation is not known in advance, when frequency varies on the time axis, or when the waveform is a non-stationary waveform.

(3) After peak points are detected in the respective waveform segmenting sections, a peak feature vector (a peak feature sequence) is generated by chronologically arranging the peak points (or feature points), the start point (a feature point) and the end point (a feature point) of the time-series data.

For example, a peak feature sequence corresponding to waveform “A” that is obtained by chronologically arranging the peak points, start and end points of waveform “A” shown in FIG. 13 is:

[(0.0, 8.5), (1.2, −20.3), (1.6, 56.0), (2.1, −21.9), (2.8, −23.1), (3.4, 52.1), (4.0, −15.6)].

Illustration of this is shown FIG. 12.

A peak feature sequence corresponding to waveform

[(0.0, 0.0), (1.4, 58.2), (1.7, 76.9), (2.4, −31.4), (3.6, −59.1), (4.0, 52.1)]

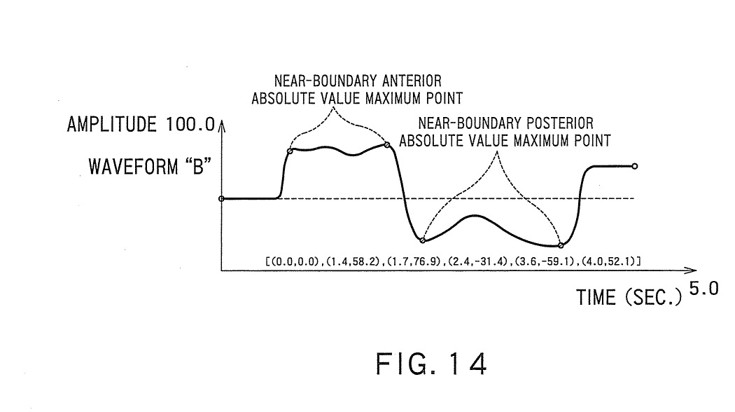

Illustration of this is shown FIG. 14.

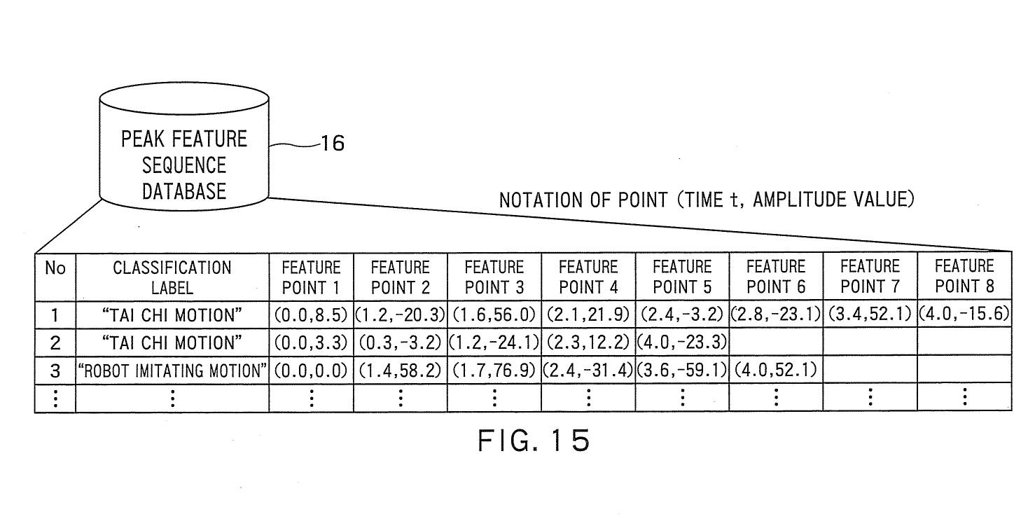

A peak feature sequence generated from time-series data in the selected waveform database 14 is stored as a case in a peak feature sequence database (a second database) 16 with a corresponding classification label. An example of the peak feature sequence database 16 is shown in FIG. 15. In the figure, a feature point 1 is the first element of a peak feature vector, a feature point 2 is the second element of the peak feature vector, . . . , and a feature point 8 is the eighth element of the peak feature vector.

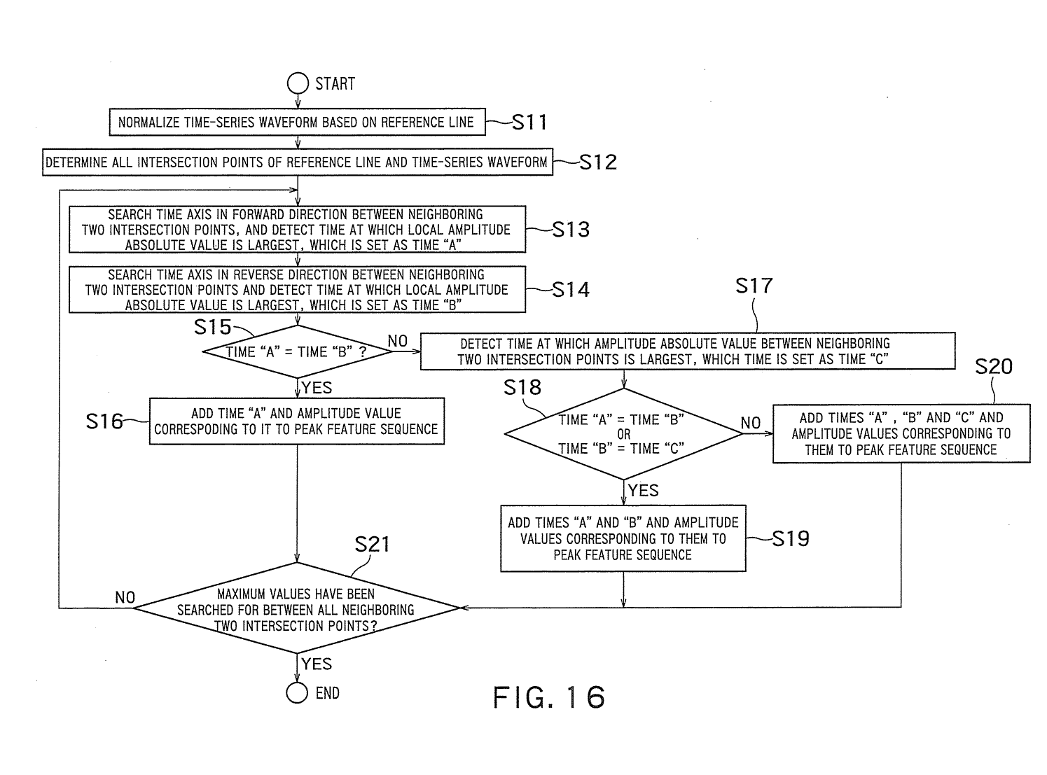

FIG. 16 is a flowchart illustrating an example of peak feature sequence detection performed by a peak feature extracting unit 15.

Time-series data (time-series data) is scaled based on the reference line (S11), and all intersection points of the reference line and the time-series waveform are identified (S12). The time axis is searched in the forward direction between neighboring intersection points (a waveform segmenting section) to detect a time which gives a local peak (the near-boundary anterior amplitude absolute value maximum time), and the time is set as time “A” (S13). Similarly, the time axis is searched in the reverse direction between neighboring intersection points (the waveform segmenting section) to detect a time which gives a local peak (the near-boundary posterior amplitude absolute value maximum time), and the time is set as time “B” (S14).

If time “A”=time “B” (YES at S15), a pair of time “A” and an amplitude value corresponding to time “A” is added to the peak feature sequence, and processing is terminated if searches have been performed between all neighboring intersection points (waveform segmenting sections) (YES at s21). Otherwise (NO at S21), processing returns to S13.

Meanwhile, if time “A” ≠ time “B” (NO at S15), a time which gives the largest amplitude in the waveform segmenting section is detected, and the time is set as time “C” (S17).

If time “C” is the same as either one of time “A” or “B” (YES at S18), a pair of time “A” and an amplitude value corresponding to time “A” and a pair of time “B” and an amplitude value corresponding to time “B” are added to the peak feature sequence (S19). If searches have been performed between all neighboring intersection points (waveform segmenting sections) (YES at S21), processing is terminated. Otherwise (NO at S21), processing returns to S13.

If time “C” is not the same as either time “A” or “B” (NO at S18), a pair of time “A” and an amplitude value corresponding to time “A”, a pair of time “B” and an amplitude value corresponding to time “B”, and a pair of time “C” and an amplitude value corresponding to time “C” are added to the peak feature sequence. If searches have been performed between all neighboring intersection points (waveform segmenting sections) (YES at S21), processing is terminated. Otherwise (NO at S21), processing returns to S13.

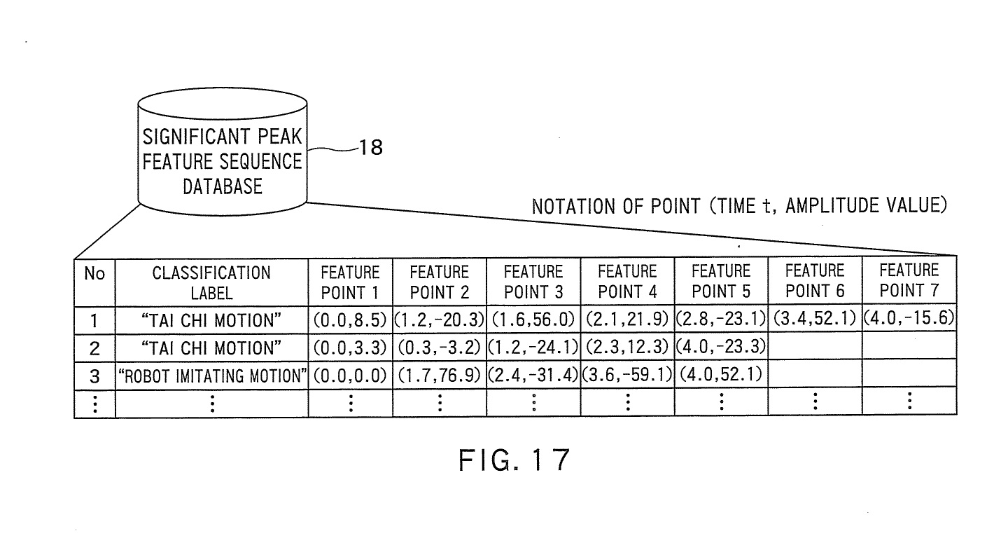

A peak selecting unit 17 uses the Leave One Out and k-Nearest Neighbor Classifier methods, for example, to generate a significant peak feature sequence (a significant peak feature vector) which is selection of a set of peak points (feature points) that play an important role at the time of classification from each peak feature sequence. Specifically, the peak selecting unit 17 generates a significant peak feature sequence that contains a set of peak points with which a correct classification label is obtained with a desired accuracy when those peak points are given to a classifier which is obtained based on the training time-series data database 11, selected waveform database 14, or peak feature sequence database 16, by selecting a plurality of peak points from each peak feature sequence. The peak selecting unit 17 then records the generated significant peak feature sequence in a significant peak feature sequence database (a third database) 18 in association with the classification labels of the peak feature sequences that have been the basis for generating the significant peak feature sequence. An example of the significant peak feature sequence database 18 is shown in FIG. 17. Exemplary processing by the peak selecting unit 17 is described below in detail.

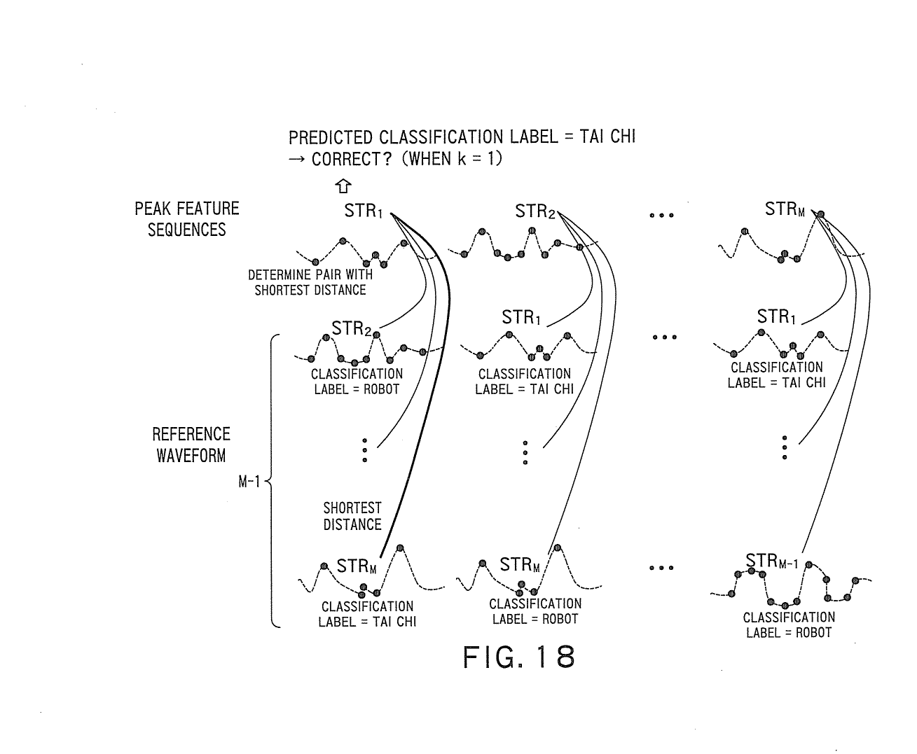

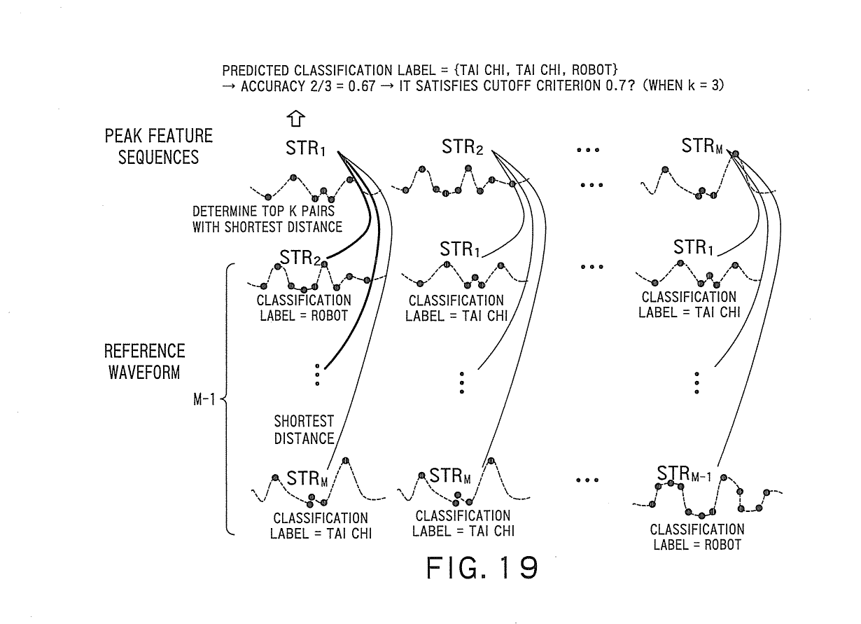

The peak selecting unit 17 selects one peak feature sequence as a test object from the peak feature sequence database 16 (which is assumed to contain M cases herein for the sake of illustration), and compares the peak feature sequence it selected with M−1 time-series data in the selected waveform database 14 except the time-series data that was the basis for generating the selected peak feature sequence (or alternatively, M−1 peak feature sequences except the selected peak feature sequence) to determine the distance between the selected peak feature sequence and each of the M−1 data. In the 1-Nearest Neighbor Classifier method, time-series data (or alternatively, a peak feature sequence) with the smallest distance is detected as shown in FIG. 18. In the k-Nearest Neighbor Classifier method with “k” being two or greater, the top k time-series data or peak feature sequences with a smaller distance are detected. An example of the 3-Nearest Neighbor Classifier method is shown in FIG. 19. Here, as the reference waveform, the distance between to N−1 time-series data in the training time-series data database 11 except the time-series data that was the basis for generating the selected peak feature sequence, as mentioned later (it is assumed that N time-series data are stored in the training time-series data database 11).

In the 1-Nearest Neighbor Classifier method, it is determined whether the classification label of time-series data (or alternatively a peak feature sequence) that has been detected corresponds with the classification label of a selected peak feature sequence. If they correspond with each other (i.e., a correct result), the selected peak feature sequence is adopted as a significant peak feature sequence as it is and recorded in the significant peak feature sequence database 18 with the corresponding classification label. In the k-Nearest Neighbor Classifier method, a correct result rate (accuracy) is calculated from the classification labels of the top k time-series data or peak feature sequences that have been detected. If the calculated accuracy satisfies a cutoff criterion, a selected peak feature sequence is determined to be a correct result and the selected peak feature sequence is adopted as the significant peak feature sequence as it is, in which case the adopted significant peak feature sequence is recorded in the significant peak feature sequence database 18 with a corresponding classification label. In the example shown in FIG. 19, a cutoff criterion given by a user in advance is 0.7 and the calculated accuracy is ⅔≈0.67, so the feature sequence is an incorrect result.

On the other hand, two classification labels do not correspond with each other in the 1-Nearest Neighbor Classifier method or when the accuracy does not satisfy the cutoff criterion (i.e., a case of an incorrect result) in the k-Nearest Neighbor Classifier method, comparison of a feature sequence with an arbitrary peak point removed from the selected peak feature sequence to M−1 time-series data (or alternatively peak feature sequences) and determination of whether the feature sequence is a correct result or an incorrect result in a similar manner are performed for each of peak points contained in the selected peak feature sequence (that is, correct results and incorrect results as many as the number of peak points are obtained from the selected peak feature sequence).

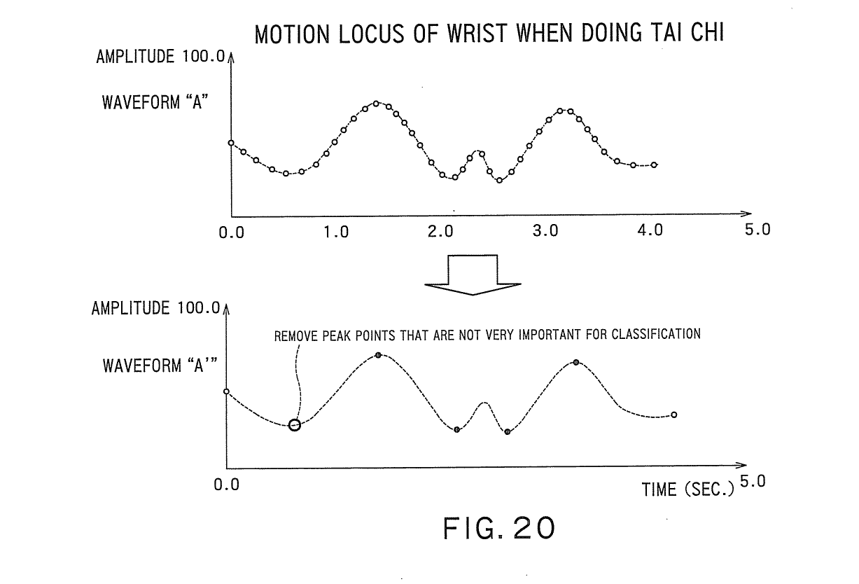

A feature sequence for which a correct result has been obtained is acquired as a significant peak feature sequence. An example of a feature sequence for which a correct result has been obtained at this point is shown in the lower portion of FIG. 20. For a feature sequence for which an incorrect result has been obtained, a feature sequence with another arbitrary peak feature point removed from the feature sequence for which the incorrect result has been obtained is compared to M−1 time-series data (or alternatively peak feature sequences) and determination is made as to whether the feature sequence is a correct result or an incorrect result for each of peak points contained in the feature sequence in a similar manner. For a feature sequence for which a correct result is not obtained even after this, the above-described processing is repeated until there are two points, the start and end points. A feature sequence for which an incorrect result has been obtained even at this point is abandoned.

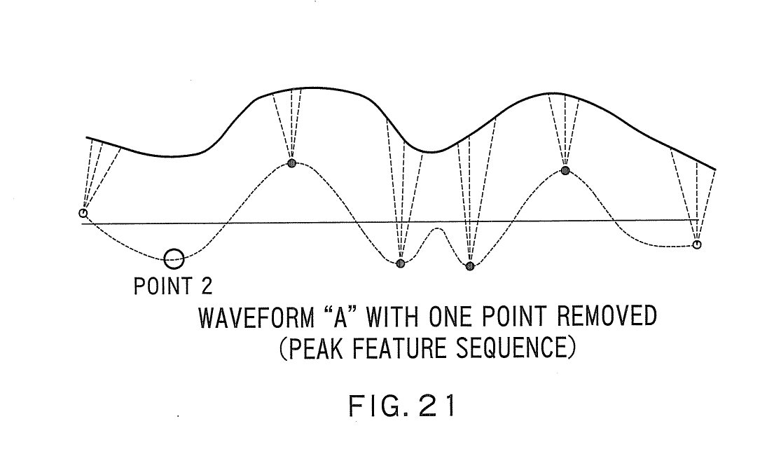

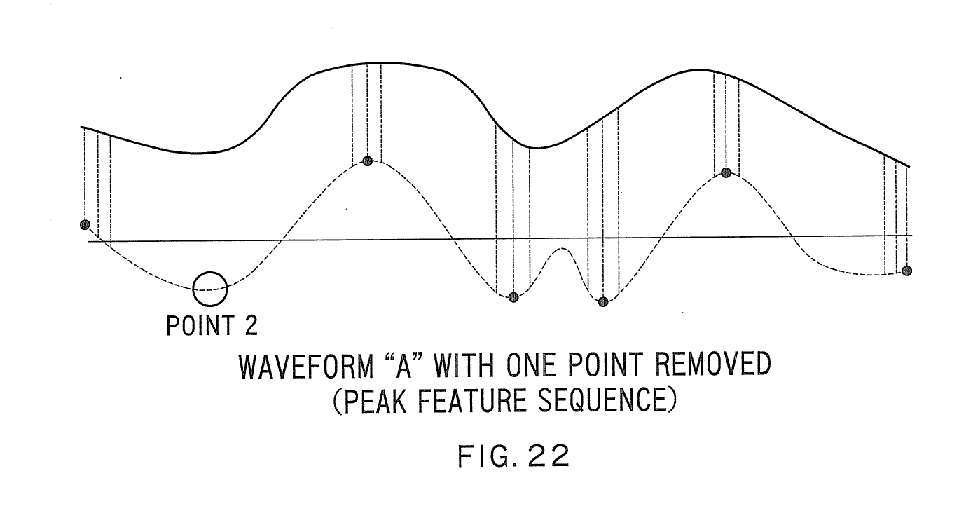

Here, an example of how to calculate the distance is briefly described. FIGS. 21 and 22 show examples of distance calculation, which show examples of determining the distance between a feature sequence with the first peak point (point 2) removed from the peak feature sequence obtained from the waveform “A” and time-series data.

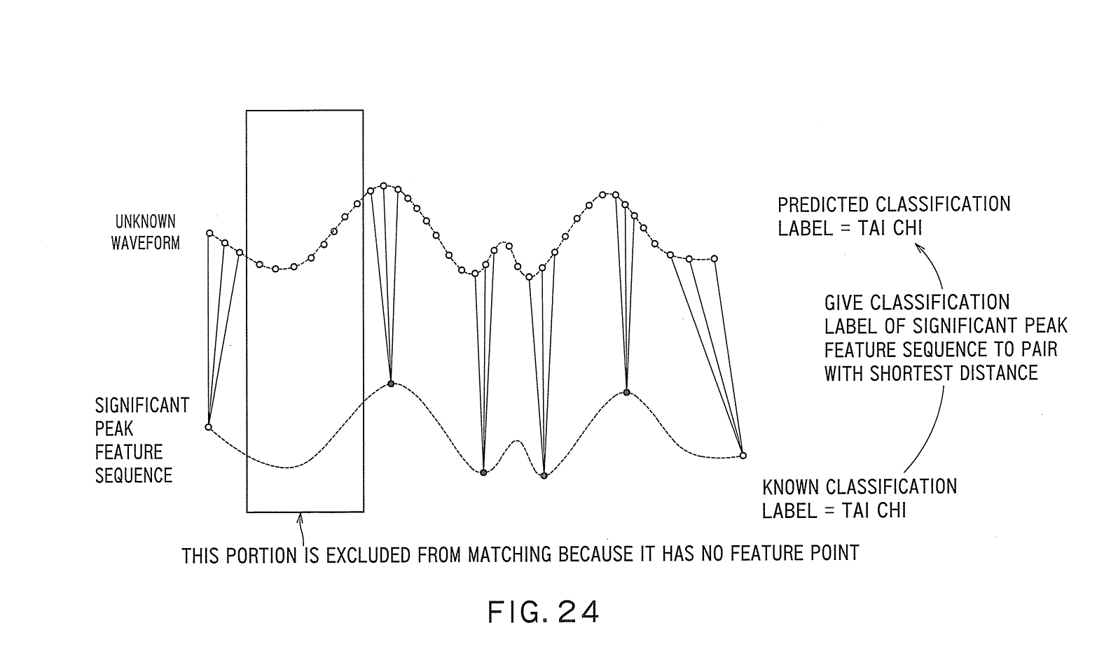

In the example of FIG. 21, a partial distance from each of points contained in the feature sequence (peak points, start or end point) to time-series data as a comparison object is determined, and the sum of partial distances is obtained as the distance. More specifically, in a set of points of time-series data as the comparison object, a partial distance to each of three points at three types of times: a time which is the same as a point of a feature sequence (a peak, start or end point) and times before and after that time, is calculated from a point of the feature sequence (see also FIG. 24 to be discussed later), and the smallest one of three partial distances calculated is selected. Then, the sum of partial distances selected for the respective points of the feature sequence is obtained as its distance. That is, partial distances to points of the time-series data that fall within a predetermined time range “R” from the times of points of the feature sequence are calculated, the smallest partial distance is selected, and the sum of partial distances selected for the respective points of the feature sequence is obtained as the distance.

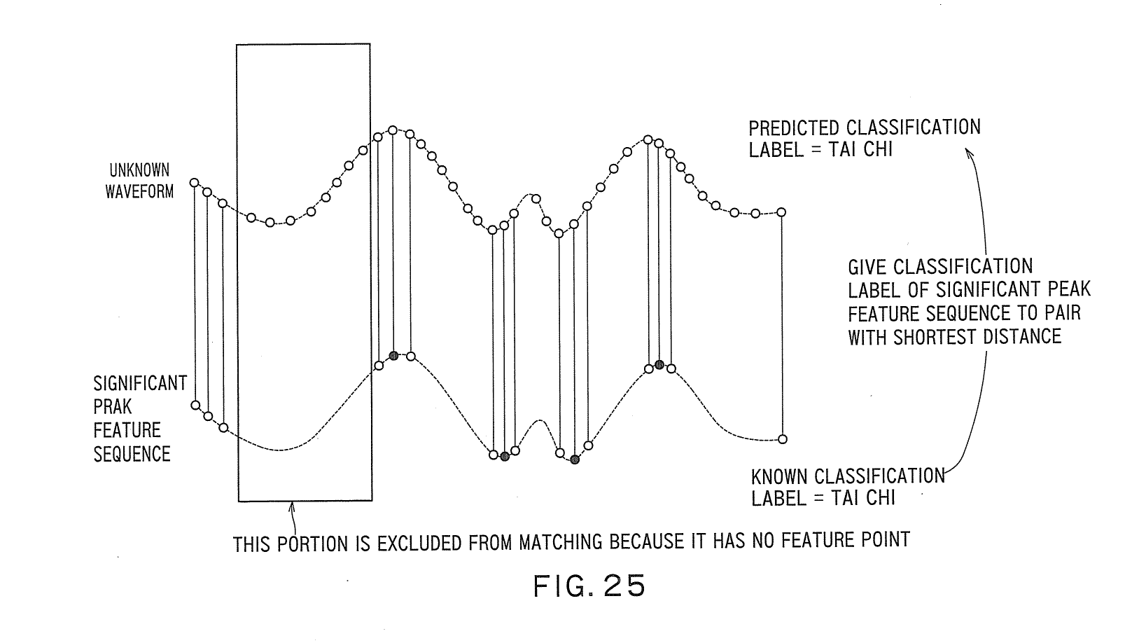

In the example of FIG. 22, points of time-series data that has been the basis for generating a feature sequence are selected within a predetermined time range “R” from points contained in this feature sequence (peak, start, or end points), and a partial distance from each of the selected points to a point at the same time in the time-series data as the comparison object is calculated. If the time-series data as the comparison object does not have a point at the same time, a point at the same time can be virtually calculated by interpolating points that are closest to that time, and a partial distance can be calculated. Specifically, FIG. 22 shows an example in which the time range “R”=3 (i.e., a time range containing only three observation times). Three points are selected: a point itself that is contained in the feature sequence, a point which is one observation time later than that point, and a point which is one observation time earlier than that point (however, for a start point “j”, the point itself, points one and two observation times later are selected. For an end point, the point itself and points one and two observation times earlier are selected) (see also FIG. 25 to be discussed later). The smallest one of partial distances from the selected points is selected, and the sum of partial distances selected for the respective points of the feature sequence is obtained as a final distance.

Although the example shown here calculates the distance between a peak feature sequence and time-series data, the distance between peak feature sequences can also be calculated in a similar approach. For example, a partial distance to a point in the other peak feature sequence that falls within a predetermined time range from a point in one peak feature sequence is calculated (when there are a number of points falling in the predetermined time range, the shortest partial distance is selected), and the sum of calculated partial distances for the respective points of the other peak feature sequence can be obtained as the distance. If there is no point in the other feature sequence that falls within the predetermined time range, a predetermined penalty value may be given to that point.

Here, the amount of calculation processing by the peak selecting unit as described above is expected to increase with an increase in the number of peak feature sequences in the peak feature sequence database 16 and the number of points contained in a peak feature sequence. One way to reduce and improve the calculation amount is to take only a randomly limited number of peak feature sequences from the peak feature sequence database 16 for comparison, that is, to take only a predetermined number of peak feature sequences as comparison objects using a random number, so that the amount of calculation and processing time can be reduced.

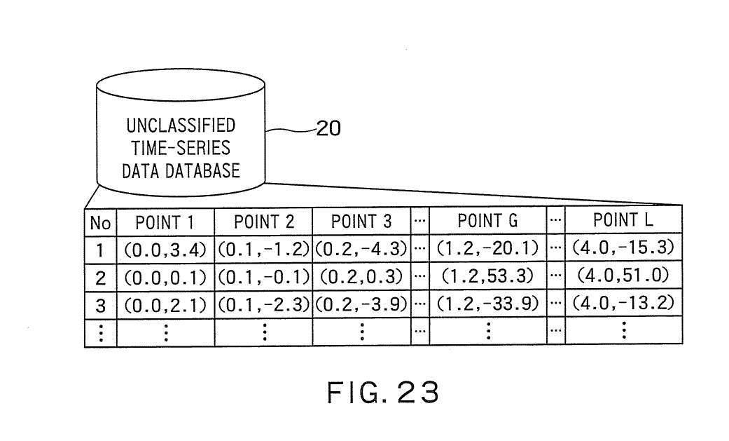

An unclassified time-series data database 19 stores a set of time-series data whose classification label is unknown (unclassified time-series data). An example of the unclassified time-series data database 19 is shown in FIG. 23.

An unclassified data inputting unit (data input unit) 20 reads out unclassified time-series data (target time-series data) from the unclassified time-series data database 19 and inputs the data to a predicting unit 21.

The predicting unit 21 uses a significant peak feature sequence in the significant peak feature sequence database 18 based on the k-Nearest Neighbor Classifier method to determine a classification label for the unclassified time-series data inputted from the unclassified data inputting unit 20. For instance, when unknown time-series data (a time-series waveform) “C” is given, the classification label for the time-series data “C” (i.e., whether the motion represented by the time-series waveform “C” is a Tai Chi motion or a robot imitating motion) is determined by measuring the distance between the time-series data “C” and a significant peak feature sequence. For example, in the 1-Nearest Neighbor Classifier method, the classification label of time-series data that has the shortest distance to the unknown waveform “C” is the result of prediction. FIGS. 24 and 25 show examples of prediction. FIG. 24 shows an example of determining a distance by a method similar to FIG. 21 described above and FIG. 25 shows an example of determining a distance by a method similar to FIG. 22 described above.

Although unknown time-series data itself is used for calculating the distance to a significant peak feature sequence here, it is also possible to perform processing by at least the former of the peak feature extracting unit 15 and the peak selecting unit 17 on time-series data whose classification label is unknown to generate a peak feature sequence or a significant peak feature sequence, and compare the peak feature sequence or significant peak feature sequence generated from the time-series data whose classification label is unknown with each significant peak feature sequence in the significant peak feature sequence database 18 so as to calculate the distance. Distance calculation in this case can be performed in a similar manner to that by the peak selecting unit 17 described above.

A result displaying unit 22 displays the result of determination (a classification label) from the predicting unit 21 and the time-series data as the target of determination on a display not shown.

As an effect of this embodiment, a significant amount of data can be reduced without degrading classification accuracy. For example, for the waveform “A”, the original time-series data has 40 observation points (sampling points) as shown in the example of FIG. 20, but the significant peak feature sequence obtained from the waveform “A” has six feature points (peak points, and start and end points): sampling points can be reduced by as much as 85% (40-6) by storing the significant peak feature sequence instead of the waveform “A”. When a plurality of significant peak feature sequences are generated from one waveform, the data amount of waveform sampling points is also actually enormous. Thus, the effect of data amount reduction can be fully obtained. In addition, by using data with reduced sampling points (a significant peak feature sequence) rather than a waveform, it is also possible to shorten processing time required for determination by the predicting unit 21. In some cases, determination can become more robust than one that uses all points (a waveform) and accuracy may be improved.

### Second Embodiment

While in the first embodiment the peak feature extracting unit 15 detects peak points in waveform segmenting section, still finer peak detection can also be performed. Specifically, when two or more peak points are detected in a waveform segmenting section, the above-described peak detection is further performed in a section defined by two of the detected peak points. This process is performed with a predetermined maximum number of iterations as a limit. This embodiment is described below in detail.

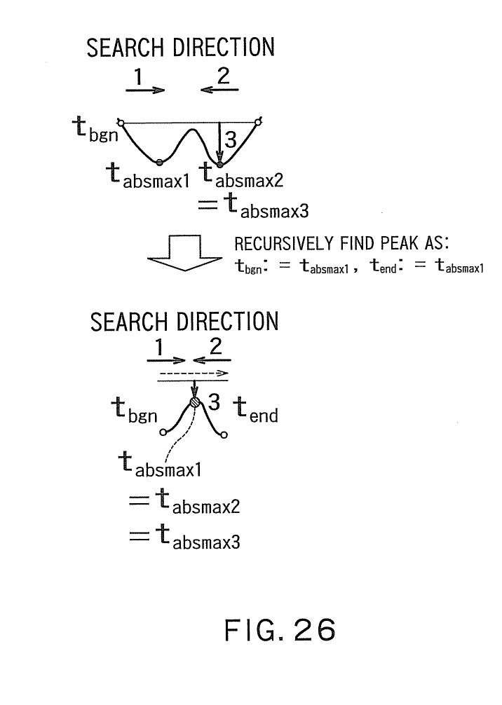

FIG. 26 shows an example of finer peak detection in the partial time-series waveform shown in FIG. 10 (Example 4).

Further peak detection is performed in a section that is defined by the near-boundary anterior amplitude absolute value maximum time and the amplitude absolute value maximum time (=the near-boundary posterior amplitude absolute value maximum time). In this example, when the maximum number of iterations is set to two or greater, only one peak point is detected in processing in the second iteration, thereupon processing is thus completed.

That is to say, in the first iteration step (the first iteration), peak detection is performed with intersection points of the reference line and the waveform as the start and end points of the section, but at the subsequent iteration steps (the second and following iterations), the section is further narrowed with the near-boundary anterior amplitude absolute value maximum time and the near-boundary posterior amplitude absolute value maximum time of the section that have been detected in the first iteration as the start and end points of the section. In the narrowed section, as in the first iteration, the amplitude absolute value maximum time, the near-boundary posterior amplitude absolute value maximum time, and the near-boundary posterior amplitude absolute value maximum time as well as corresponding amplitude values are determined. When an algorithm stop condition (e.g., only one peak point has been detected) is met, iterative processing for the current section is stopped at that point even if the present number of iterations is less than the maximum number of iterations predefined by the user.

### Third Embodiment

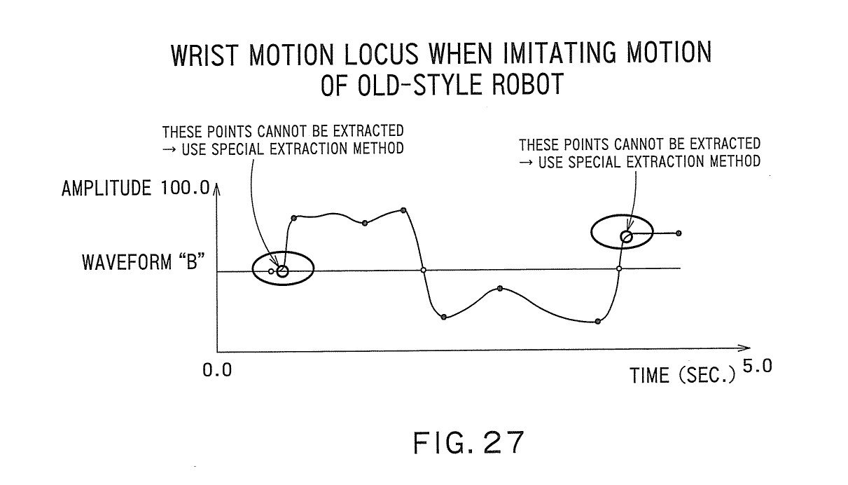

This embodiment is intended to also extract feature points that cannot be detected by the methods of the first and second embodiments. For example, such a point as shown in FIG. 27 (a bend) cannot be extracted by the methods of the first and second embodiments. This embodiment also extracts such a point as a feature point of a waveform (time-series data).

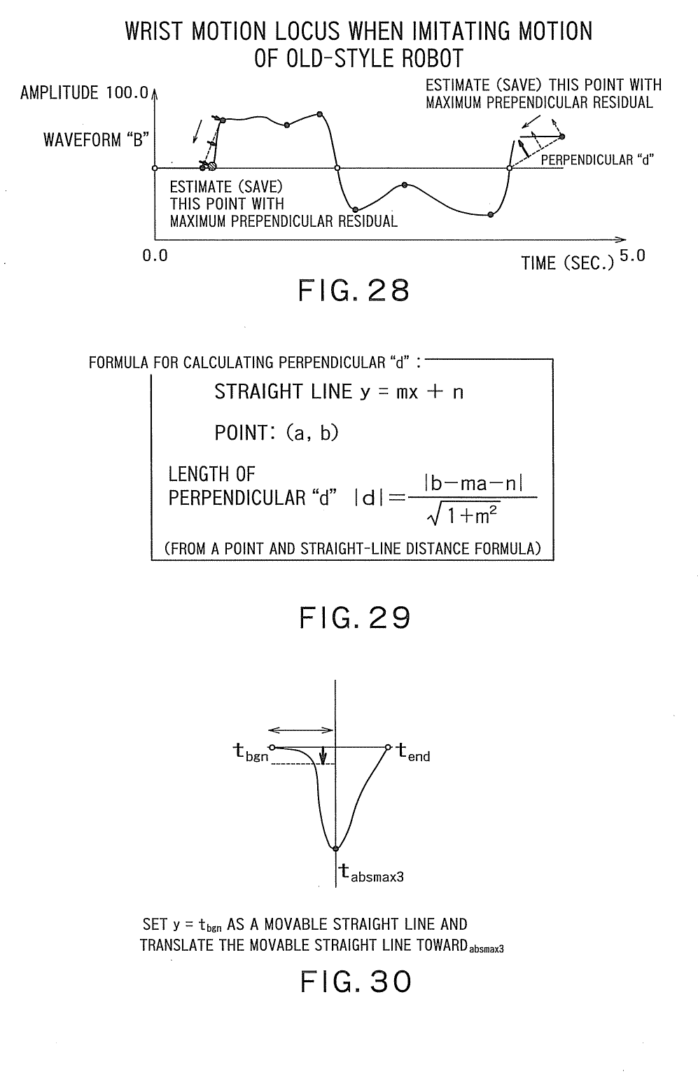

FIG. 28 illustrates an example of processing by the peak feature extracting unit 15 in this embodiment.

The peak feature extracting unit 15 connects arbitrary neighboring points with a line segment in a point set including the start and end points of time-series data, intersection points of the time-series data and the reference line, and peak points extracted from respective sections. The peak feature extracting unit 15 then draws a perpendicular from the connecting line segment to the time-series data, and detects as a feature point an intersection point of the perpendicular and the time-series data as when the length of the perpendicular is longest. The length of the perpendicular can be calculated by the formula shown in FIG. 29, for example. The peak feature extracting unit 15 includes the feature point thus extracted in the peak feature sequence. Such a method enables extraction of a characteristic bend in time-series data as a feature point.

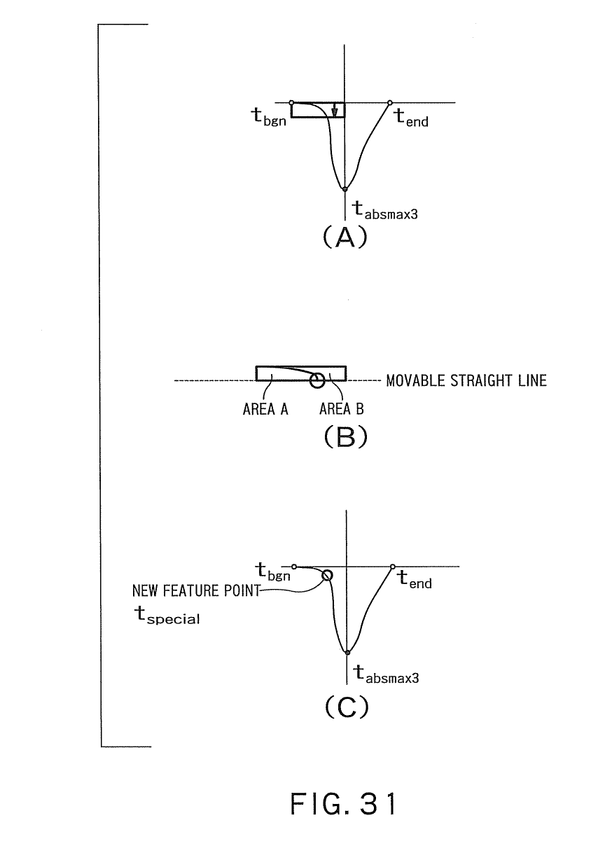

FIGS. 30 and 31 illustrate another example of processing by the peak feature extracting unit 15 in this embodiment.

As illustrated in FIGS. 30 and 31A, a movable straight line that passes through a section start point t_{bgn} (alternatively an end point t_{end}) or a certain peak point detected t_{absmax3} and is parallel with the time axis is translated toward the peak point t_{absmax3} or the section start point t_{bgn} in a direction perpendicular to the time axis. The translation is assumed to move data points (observation points) in a waveform one by one or at regular intervals. An intersection point of the movable straight line and the time-series waveform is detected as a feature point as shown in FIG. 31C as when a rectangular area which is surrounded by a straight line that passes through the section start point (alternatively the section end point) and is parallel with the time axis, the reference line, the movable straight line, and a line that passes through the peak point and is parallel with the time axis is divided in two parts at a predetermined ratio by the time-series waveform (time-series data) as shown in FIG. 31B. The peak feature extracting unit 15 includes the feature point thus extracted in the peak feature sequence. Such a method enables extraction of a characteristic bend in time-series data as a feature point.

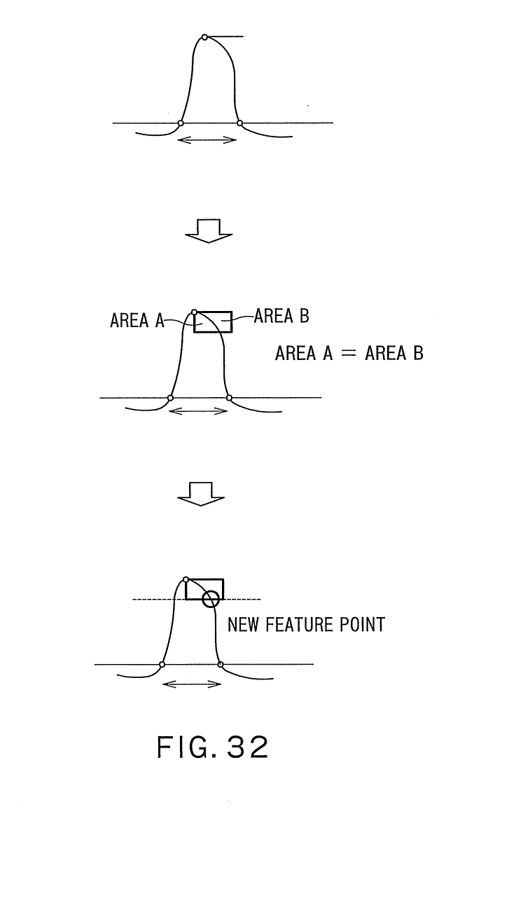

For a waveform having a convex upward as shown in FIG. 32 as well, the characteristic bend can be extracted as a feature point in a similar manner to FIGS. 30 and 31. That is, first and second straight lines that are parallel with the time axis and pass through the peak point detected from the section are set, and the second straight line is moved toward the start or end point of the section in a direction perpendicular to the time axis. Then, an intersection point of the second straight line and the time-series data is detected as when an area surrounded by a straight line that passes through the section start or end point and is parallel with the time axis, the first straight line, the second straight line, and a line that passes through the peak point and is parallel with the time axis is divided by the time-series data at a predetermined ratio. The peak extracting unit 15 includes the detected intersection point in the peak feature sequence.

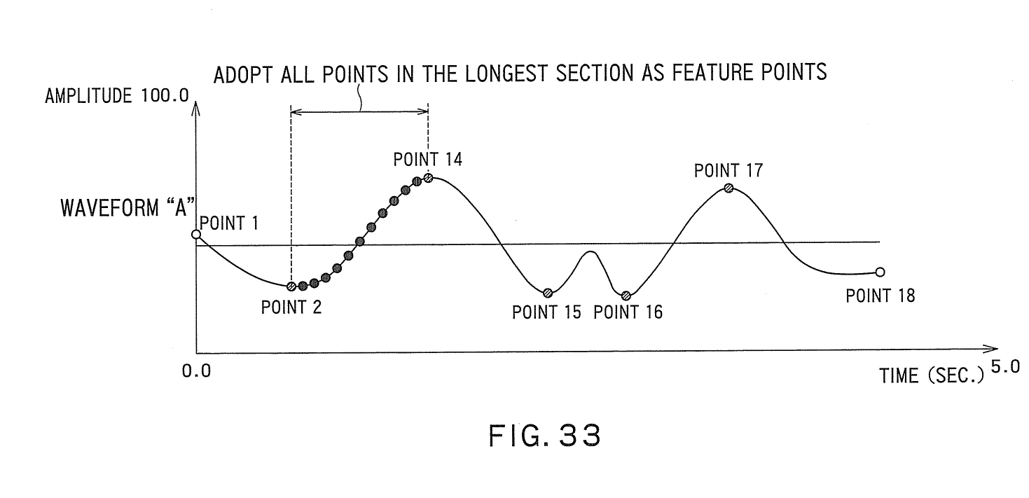

When it is desired to increase feature points, all points in a section having the largest length found in the waveform that is defined by neighboring feature points found in the peak feature sequence may be adopted as in FIG. 33. By doing so, although data reduction effect is somewhat sacrificed, there will be provided effects that the distance between peak feature points becomes closer to the distance between the original waveforms and distance calculation becomes more accurate.

### Fourth Embodiment

This embodiment is characterized in that processing by the peak selecting unit 17 and the predicting unit 21 mentioned in the first embodiment is extended.

The peak selecting unit 17 in this embodiment re-sorts significant peak feature sequences with their accuracy as a key (or alternatively an accuracy class determined in accordance with accuracy) when storing significant peak feature sequences in the significant peak feature sequence database 18. Since this requires the ability to calculate accuracy itself, it is used only when the peak selecting unit 17 employs a Nearest Neighbor Classifier method with “k”>1 (see FIG. 19). At the time of prediction, the predicting unit 21 performs prediction using only data with a high accuracy, for example, among significant peak feature sequences thus sorted with their accuracy (or accuracy class) as a key. For example, when a threshold value for processing time has been given, processing is performed using significant peak feature sequences with higher accuracy first in sequence until the threshold time is reached, processing is terminated when the threshold time has been reached, and a result of determination is obtained based on processing results so far. This can obtain a prediction result in a short time period and with a high accuracy.

The peak selecting unit 17 also calculates the significance of a peak point contained in each peak feature sequence based on the accuracy of the peak feature sequence. The predicting unit 21 uses only peak points with high significance first (e.g., the top X peak points) (or the start and end points may be always used) to predict a classification label and performs prediction sequentially adding peak points in descending order of significance as long as time permits so as to monotonically improve classification accuracy. This means that classification can be rendered into an anytime algorithm and is expected to have an effect of attaining an almost highest accuracy of classification in a small amount of time (see [Ueno 06] Ken Ueno, Xiaopeng Xi, Eamonn Keogh, Dah-Jye Lee: “Anytime Classification Using the Nearest Neighbor Algorithm with Applications to Stream Mining”, pp. 623-632, In Proc. of the Sixth International Conference on Data Mining (ICDM'06), 2006).

In the following, how to calculate significance will be described.

The peak selecting unit 17 arranges significant peak feature sequences having the same classification label in a coordinate system that has a time axis and an observed-value axis, segments the time axis at intervals of a predetermined time length, and calculates the significance “wj” of peak points of the significant peak feature sequences that exist in a cluster within the same time range.

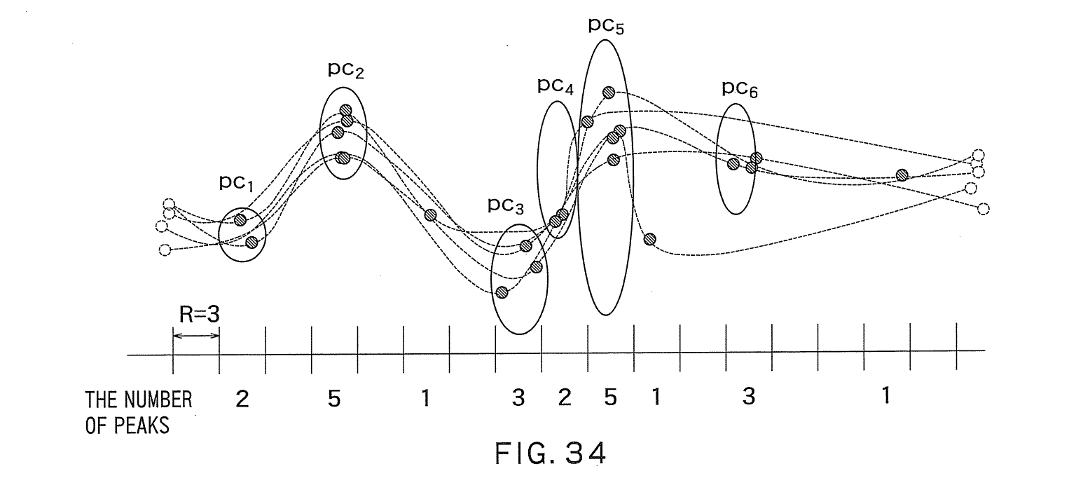

FIG. 34 shows an example where five significant peak feature sequences are arranged in the coordinate system and the time axis is segmented with a time width “R”=3. “R”=3 is equivalent to a time width that contains three observation times (=the interval between neighboring observation times×3), for example. Here, assuming that only a section containing two or more peak points is treated as a peak cluster “pc1.”, six peak clusters “pcd” to “pc6” are obtained, where “pc1”={4,5}, “pc2”={1,2,3,4,5}, . . . , “pc6”={1,2,4}. Figures in { } are the IDs of the significant peak feature sequences. Assuming that the number of peak points contained in a peak cluster “pcj” is “fpj”, the accuracy of a significant peak feature sequence is “acci” (“i” is the ID of a significant peak feature sequence), and the number of significant peak feature sequences having the same classification label is “N”, the significance “wj” of a peak point contained in a peak cluster “pcj” can be calculated according to the formula below. However, the significance of a peak point that is not contained in any peak cluster is assumed to be 0.

$${w}_{j} = \frac{{\sum }_{i ∈ {ID}_{j}} {acc}_{i}}{{fp}_{j} \cdot N} \qquad [ Formula 2 ]$$

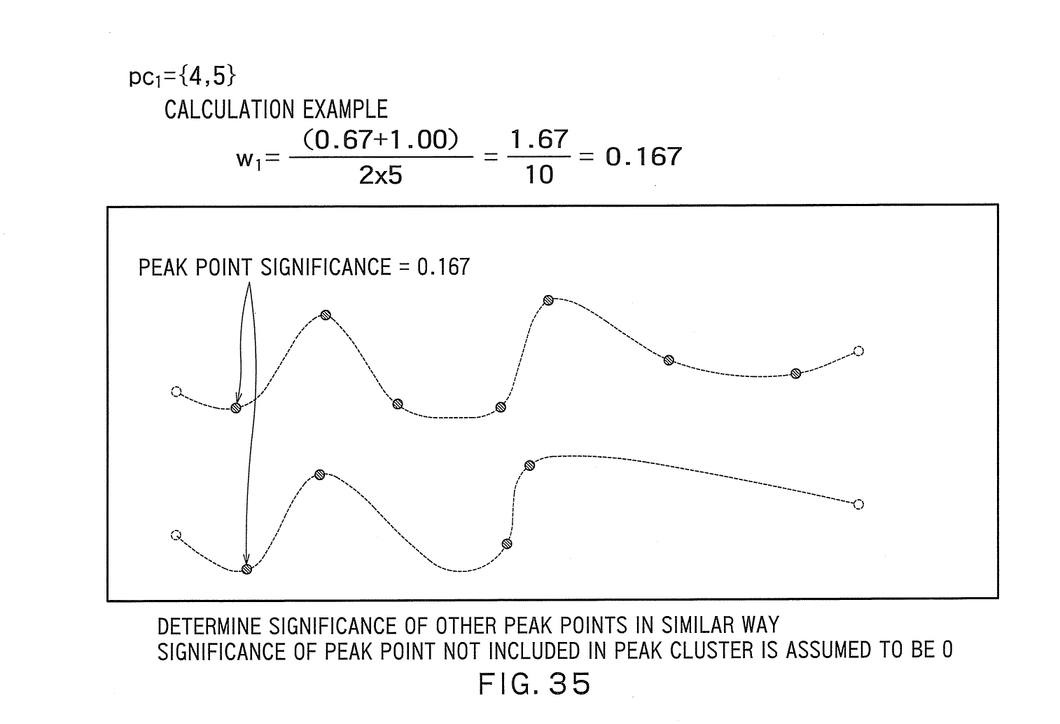

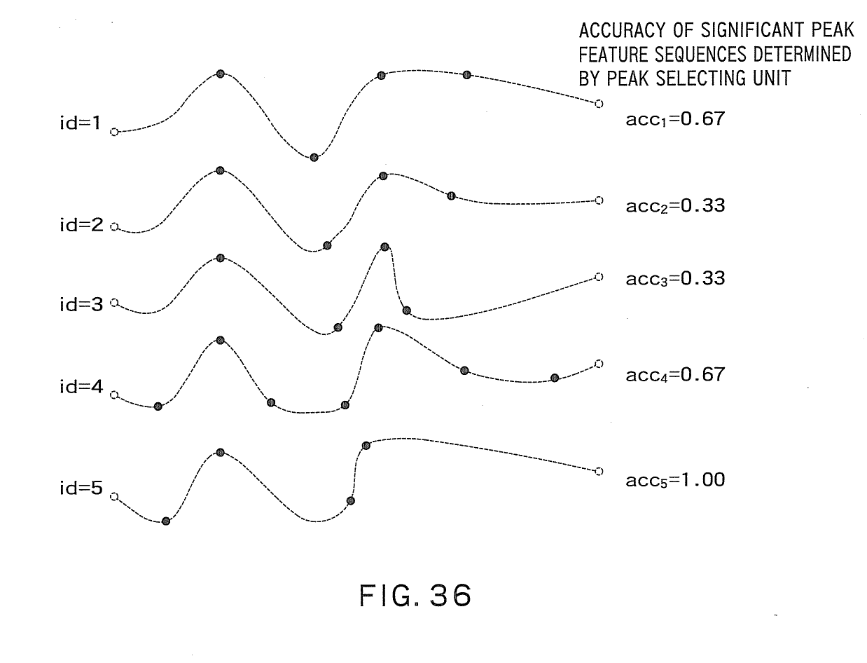

For example, the significance “w1” of a peak point contained in a peak cluster “pc1” is 0.167, as illustrated in FIG. 35. However, it is assumed that the accuracy of significant peak feature sequences has been already calculated as in FIG. 36.

### Fifth Embodiment

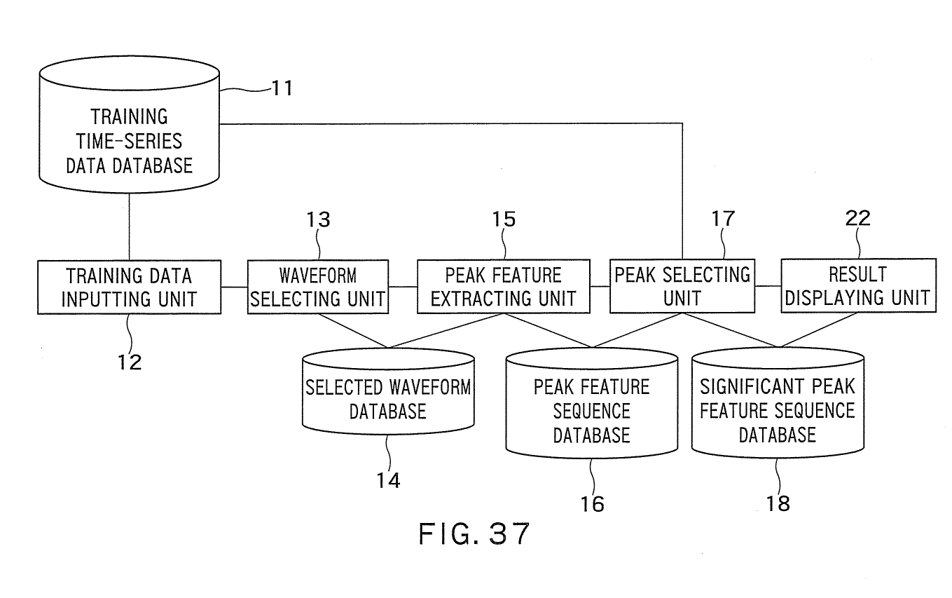

FIG. 37 is a block diagram showing a configuration of a time-series data reducing apparatus (a time-series data processing apparatus) as the present embodiment.

This apparatus is equivalent to the time-series data classifying apparatus of FIG. 1 excluding the predicting unit 21 and the unclassified time-series data database 19. A significant amount of data can be reduced without losing important features of time-series data by generating and saving a significant peak feature sequence from time-series data read out from the training time-series data database 11 and deleting a case that includes time-series data that has been the basis for generating the significant peak feature sequence from the training time-series data database 11, for example. The apparatus may also have a time-series data deleting unit for deleting time-series data from which a peak feature sequence or significant peak feature sequence has been generated from the training time-series data database 11.

The peak selecting unit 17 may also determine the accuracy of each significant peak sequences and select only significant peak sequences that have an accuracy exceeding a predetermined cutoff criterion and store them in the significant peak feature sequence database 18. This can reduce the data amount for storing without losing as many features of time-series data as possible in accordance with the size of a data storing area when the size is limited in advance.

Also, as mentioned in the first embodiment, the amount of calculation processing by the peak selecting unit 17 is expected to increase with an increase in the number of peak feature sequences in the peak feature sequence database 16 and the number of points contained in a peak feature sequence. Therefore, as a way to reduce and improve the calculation amount, only a randomly limited number of peak feature sequences are taken from the peak feature sequence database 16 for comparison, that is, only a predetermined number of peak feature sequences as comparison objects are taken using a random number, so that the amount of calculation and processing time can be reduced. In addition, as mentioned above, when a peak feature sequence is compared to time-series data to determine the distance between them, a similar effect is expected to be provided by taking only a randomly limited number of time-series data from the training time-series data database 11 for comparison.

Relations between JP-A 07-141384 (Kokai), JP-A 2007-49509 (Kokai) and JP-A 2006-338373 (Kokai) and the present invention are briefly described below.

JP-A 07-141384 (Kokai) primarily aims to assign a symbol label based on inputted (time-series) numerical data for plain presentation of data patterns to user and describes that use of the method facilitates automated classification. However, the method has a problem that the granularity of information becomes very large when (time-series) numerical data has been converted to a finite symbol label and the accuracy of classification is expected to be potentially degraded due to effects on result by noise contained in the data and/or phase shift. The proposal by the present invention does not perform conversion to symbols and is different from the scheme described in this patent document.

JP-A 2007-49509 (Kokai) describes reduction of time-series data without degrading accuracy of identification in a bill identifying apparatus and the like. Although the scheme is similar to the present invention in that it reduces data for the purpose of identification, the scheme is basically a method of compression by way of average calculation and differs from the scheme proposed by the present invention.

JP-A 2006-338373 (Kokai) defines minimum sections with a predetermined division window width and then calculates a feature amount. It assigns a symbol label to each waveform using the feature amount and determines the regularity of a plurality of waveforms, which is different from the problem addressed by the proposal of the present patent.

What is claimed is:

1. A time-series data classifying apparatus, comprising:
a first database configured to store a plurality of cases each including
time-series data in which an observed value obtained by observing an observation object is sequentially recorded in associated with an observed time and
a classification label that represents a state or type of the observation object as when the observation object is observed;
a peak feature extracting unit configured to, for each of the cases,
expand the time-series data in a coordinate system which is made up of a time axis and a value axis representing the observed value,
set along the time axis a reference line that intersects expanded time-series data,
detect intersection points of the expanded time-series data and the reference line, and
detect a peak point of the expanded time-series data in each of sections each formed between two intersection points being adjacent to generate a peak feature sequence that contains the peak point detected in each of the sections;
a second database configured to store the peak feature sequence generated for each of the cases in association with a classification label of each of the cases;
a data input unit configured to input target time-series data; and
a predicting unit configured to predict a classification label to be assigned to the target time-series data, based on the second database.

2. The apparatus according to claim 1, wherein the peak feature extracting unit sets the reference line by determining a reference value in a direction of the value axis and drawing a line that passes the reference value and is parallel with the time axis.

3. The apparatus according to claim 1, wherein the peak feature extracting unit detects a first peak point which is found first by performing a search from a section start point of the two intersection points forming the section toward a section end point of the two intersection points, and a second peak point which is found first by performing a search from the section end point toward the section start point.

4. The apparatus according to claim 3, wherein the peak feature extracting unit further detects a third peak point that has a largest amplitude in each of the sections.

5. The apparatus according to claim 4, wherein the peak feature extracting unit omits detecting of the third peak point when the first peak point is identical with the second peak point.

6. The apparatus according to claim 1, wherein when the peak feature extracting unit has detected a plurality of peak points from one section, the peak feature extracting unit further performs peak detection for a partial section formed between two points selected from among detected peak points.

7. The apparatus according to claim 1, wherein the peak feature extracting unit detects an intersection point of the expanded time-series data and a maximum perpendicular and includes a detected intersection point in the peak feature sequence additionally, the maximum perpendicular being a perpendicular of a largest length among perpendiculars from a line segment connecting two neighboring points selected among from start and end points of the expanded time-series data, the intersection points of the expanded time-series data and the reference line and peak points detected in the sections, to the expanded time-series data.

8. The apparatus according to claim 1, wherein
the peak feature extracting unit
moves a movable straight line that passes through a section start or end point of a certain section and is parallel with the time axis, toward the peak point in the certain section and perpendicularly to the time axis, and detects an intersection point of the movable straight line and the expanded time-series data as when an area surrounded by a line that passes through the section start or end point and is perpendicular to the time axis, the reference line, the movable straight line, and a line that passes through the peak point and is perpendicular to the time axis is divided by the expanded time-series data at a predetermined ratio, and
includes a detected intersection point in the peak feature sequence additionally.

9. The apparatus according to claim 1, wherein
the peak feature extracting unit
sets first and second straight lines that pass through a peak point detected in a certain section and are parallel with the time axis,
moves the second straight line toward a section start or end point of the certain section and perpendicularly to the time axis, and
detects an intersection point of the second straight line and the expanded time-series data as when an area surrounded by a line that passes through the section start or end point and is perpendicular to the time axis, the first straight line, the second straight line, and a line that passes through the peak point and is perpendicular to the time axis is divided by the expanded time-series data at a predetermined ratio, and
includes a detected intersection point in the peak feature sequence additionally.

10. The apparatus according to claim 1, further comprising:
a peak selecting unit configured to, for each of peak feature sequences in the second database, select a plurality of peak points from the peak feature sequence to generate a significant peak feature sequence that contains selected peak points in which a correct classification label is obtained with a desired accuracy when the selected peak points is given to a classifier generated based on the first or second database; and
a third database configured to store each generated significant peak feature sequence in association with the classification label corresponding to each of the peak feature sequences, wherein
the predicting unit predicts a classification label to be assigned to the target time-series data based on the third database.

11. The apparatus according to claim 10, wherein
the peak selecting unit calculates a classification accuracy of each generated significant peak feature sequence, respectively; and
the predicting unit performs prediction of the classification label by preferentially using significant peak feature sequences having a higher classification accuracy.

12. The apparatus according to claim 10, wherein
the peak selecting unit calculates a classification accuracy of each generated significant peak feature sequence, respectively and
the third database stores only significant peak feature sequences having the classification accuracy that satisfies a cutoff criterion.

13. The apparatus according to claim 10, wherein
the peak selecting unit calculates a classification accuracy of each generated significant peak feature sequence respectively and calculates significances of points contained in each generated significant peak feature sequence respectively by utilizing the classification accuracy of each generated significant peak feature sequence,
the predicting unit performs prediction of the classification label within a threshold time period while gradually increasing a number of points to be used for the prediction by preferentially selecting a point with a higher significance in each significant peak feature sequence respectively.

14. The apparatus according to claim 13, wherein the peak selecting unit sections each generated significant peak feature sequence at intervals of a predetermined time period, respectively and
calculates significances of points contained in each section in each sectioned significant peak feature based on a number of points contained in said each section, a number of each generated significant peak feature sequence, and a calculated classification accuracy of each generated significant peak feature sequence.

15. The apparatus according to claim 10, wherein the peak selecting unit selects a plurality of points from a certain peak feature sequence,
calculates a distance between a sequence of selected points and each time-series data in the first database or each peak feature sequence in the second database, respectively, and
when the classification accuracy calculated based on top k (k being an integer equal to 1 or greater) time-series data or peak feature sequences having a shortest distance satisfies the desired accuracy, adopts the sequence of the selected points as the significant peak feature sequence corresponding to the certain peak feature sequence.

16. The apparatus according to claim 15, wherein the peak selecting unit selects a predetermined number of time-series data or peak feature sequences for which the distance to the sequence of the selected points is to be calculated from the first or second database by using a random number.

17. The apparatus according to claim 1, further comprising:
a case selecting unit configured to select from the first database, cases with which a correct classification label is obtained with a desired accuracy when the time-series data of the cases is given to a classifier generated based on the first database; and
a fourth database configured to store selected cases, wherein
the peak feature extracting unit generates the peak feature sequence for each of cases in the fourth database.

18. The apparatus according to claim 1, further comprising a noise removing unit configured to remove noise contained in each time-series data in the first database.

19. The apparatus according to claim 1, further comprising a displaying unit configured to display a classification label predicted by the predicting unit.

20. A time-series data classifying apparatus, comprising:
a first database configured to store a plurality of cases each including
time-series data in which an observed value obtained by observing an observation object is sequentially recorded in associated with an observed time and
a classification label that represents a state or type of the observation object as when the observation object is observed;
a peak feature extracting unit configured to, for each of the cases,
expand the time-series data in a coordinate system which is made up of a time axis and a value axis representing the observed value,
set along the time axis a reference line that intersects expanded time-series data,
detect intersection points of the expanded time-series data and the reference line, and
detect a peak point of the expanded time-series data in each of sections each formed between two intersection points being adjacent to generate a peak feature sequence that contains the peak point detected in each of the sections;
a second database configured to store the peak feature sequence generated for each of the cases in association with a classification label of each of the cases.

21. The apparatus according to claim 20, further comprising a time-series data deleting unit configured to delete from the first database a case for which the peak feature sequence has been generated.

22. The apparatus according to claim 20, further comprising:
a peak selecting unit configured to, for each of peak feature sequences in the second database, select a plurality of peak points from the peak feature sequence to generate a significant peak feature sequence that contains selected peak points in which a correct classification label is obtained with a desired accuracy when the selected peak points is given to a classifier generated based on the first or second database; and
a third database configured to store each generated significant peak feature sequence in association with the classification label corresponding to each of the peak feature sequences.

23. The apparatus according to claim 22, wherein
the peak selecting unit calculates a classification accuracy of each generated significant peak feature sequence, respectively and
the third database stores only significant peak feature sequences having the classification accuracy that satisfies a cutoff criterion.

24. The apparatus according to claim 21, wherein
the peak selecting unit
selects a plurality of points from a certain peak feature sequence,
calculates a distance between a sequence of selected points and each time-series data in the first database or each peak feature sequence in the second database, respectively,
when the classification accuracy calculated based on top k (k being an integer equal to 1 or greater) time-series data or peak feature sequences having a shortest distance satisfies the desired accuracy, adopts the sequence of the selected points as the significant peak feature sequence corresponding to the certain peak feature sequence, and
selects a predetermined number of time-series data or peak feature sequences for which the distance to the sequence of the selected points is to be calculated from the first or second database by using a random number.

25. A time-series data classifying method, comprising:
providing a first database which stores a plurality of cases each including
time-series data in which an observed value obtained by observing an observation object is sequentially recorded in associated with an observed time and
a classification label that represents a state or type of the observation object as when the observation object is observed;
for each of the cases, expanding the time-series data in a coordinate system which is made up of a time axis and a value axis representing the observed value, setting along the time axis a reference line that intersects expanded time-series data, detecting intersection points of the expanded time-series data and the reference line, and detecting a peak point of the expanded time-series data in each of sections each formed between two intersection points being adjacent to generate a peak feature sequence that contains the peak point detected in each of the sections;
storing the peak feature sequence generated for each of the cases in association with a classification label of each of the cases, in a second database;
inputting target time-series data; and
predicting a classification label to be assigned to the target time-series data based on the second database.
